(19) United States
(12) Patent Application Publication
(10) Pub. No.: US 2026/0034721 A1
(43) Pub. Date: Feb. 5, 2026

(54) METHODS FOR CREATING FUNCTIONALLY GRADED FOAMS USING HIGH VISCOSITY LIQUIDS

(71) Applicants: VIRGINIA TECH INTELLECTUAL PROPERTIES, INC., Blacksburg, VA (US); NUtech Ventures, Lincoln, NE (US)

(72) Inventors: Eric Markvicka, Lincoln, NE (US); Spencer Pak, Lincoln, NE (US); Michael D. Bartlett, Blacksburg, VA (US)

(21) Appl. No.: 19/291,252

(22) Filed: Aug. 5, 2025

Related U.S. Application Data
(60) Provisional application No. 63/679,454, filed on Aug. 5, 2024.

(51) Int. Cl. B29C 64/112; B29K 105/00; B29K 105/04; B33Y 10/00; B33Y 70/10; B33Y 80/00; C08K 3/08; C09D 7/61

(52) U.S. Cl. CPC B29C 64/112; B33Y 10/00; B33Y 70/10; B33Y 80/00; C09D 7/61; B29K 2105/0064; B29K 2105/04; C08K 3/08

(57) ABSTRACT

Embodiments of functionally graded pure and composite 3D printed articles having nonporous regions and porous regions are described. In one example, a printed composite article includes a polymer matrix including a porous region. The printed composite article further includes a plurality of liquid metal elements embedded in the polymer matrix. In another example, a printed article includes a polymer matrix including a nonporous region and a porous region adjacent to and at least partly integrated with or coupled to the nonporous region. The porous region includes porous polymer material having an increasing porosity or a decreasing porosity in at least one direction relative to a longitudinal axis of at least one of the polymer matrix or the printed article.

### CROSS REFERENCE TO RELATED APPLICATIONS

This application claims the benefit of and priority to U.S. Provisional Application Ser. No. 63/679,454, filed Aug. 5, 2024, titled “METHODS FOR CREATING FUNCTIONALLY GRADED FOAMS USING HIGH VISCOSITY LIQUIDS,” the entire contents of which are hereby incorporated herein by reference.

### GOVERNMENT LICENSE RIGHTS

This invention was made with government support under Grant Nos. 2054411-UNL and 2054409-VT awarded by the National Science Foundation. The government has certain rights in the invention.

### BACKGROUND

Direct ink write (DIW) three-dimensional (3D) printing is an additive manufacturing technique that allows for precisely controlled fabrication of intricate structures by extrusion of high-viscosity fluids through a fine nozzle. DIW can be used to create fully dense and porous solids, high aspect ratio structures, and spanning elements for diverse fields including soft robotics, stretchable and wearable electronics, biomedical applications, and human-machine interfaces. During DIW, ink composition and print processing parameters can be tailored to achieve precise control of filament structure across different length scales, which directly influences various properties of a printed object. The occurrence of voids within a DIW printed structure is common. Voids can arise from entrapment of air during the extrusion process. Recently, shear-induced alignment has also been demonstrated during DIW printing of a variety of ink compositions and fillers such as liquid metal (LM) microdroplets. The alignment of the fillers allows for the creation of programmed anisotropic functional properties in a printed article.

### SUMMARY

Described herein are embodiments of functionally graded pure and composite 3D printed articles having nonporous regions and porous regions. Also described herein are embodiments of a method to form such pure and composite 3D printed articles using a direct ink write printing process. Leveraging a reference nozzle print height below which significant surface roughness occurs and ink fracture occurs above, the embodiments include or can be implemented to create porous and nonporous structures with at least one of tunable stiffness or programmable LM microstructure. For instance, the embodiments can be implemented to simultaneously manipulate LM microstructure and geometric architecture in LM elastomer composites through precise control of print parameters, while maintaining geometric fidelity in a printed design.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, a printed composite article includes a polymer matrix including a porous region. The printed composite article further includes a plurality of liquid metal elements embedded in the polymer matrix.

According to another example embodiment, a printed article includes a polymer matrix including a nonporous region and a porous region adjacent to and at least partly integrated with or coupled to the nonporous region. The porous region includes porous polymer material having an increasing porosity or a decreasing porosity in at least one direction relative to a longitudinal axis of at least one of the polymer matrix or the printed article.

According to another example embodiment, an additive manufacturing process includes direct ink write printing a first layer of viscoelastic emulsion ink at a first linear nozzle velocity and a first nozzle height relative to a first surface to form a first plurality of liquid metal elements embedded in a nonporous layer of viscoelastic material on the first surface. The additive manufacturing process further includes direct ink write printing a second layer of viscoelastic emulsion ink at a second linear nozzle velocity and a second nozzle height relative to a second surface to form a second plurality of liquid metal elements embedded in a porous layer of viscoelastic material on the second surface. The second nozzle height relative to the second surface is higher than the first nozzle height relative to the first surface. Individual elements among each of the first plurality of liquid metal elements and the second plurality of liquid metal elements are formed to have at least one of a same longitudinal geometry, a same cross-sectional geometry, or a same aspect ratio relative to one another.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1A illustrates a top-down view of an example printed article according to various aspects and embodiments of the present disclosure.

FIG. 1B illustrates a bottom-up view of the printed article shown in FIG. 1A according to various aspects and embodiments of the present disclosure.

FIG. 1C illustrates the cross-sectional view of the printed article designated A-A in FIG. 1A according to various aspects and embodiments of the present disclosure.

FIG. 1D illustrates the cross-sectional view of the printed article designated B-B in FIG. 1C according to various aspects and embodiments of the present disclosure.

FIG. 2A illustrates a top-down view of another example printed article according to various aspects and embodiments of the present disclosure.

FIG. 2B illustrates a bottom-up view of the printed article shown in FIG. 2A according to various aspects and embodiments of the present disclosure.

FIG. 2C illustrates the cross-sectional view of the printed article designated C-C in FIG. 2A according to various aspects and embodiments of the present disclosure.

FIG. 2D illustrates the cross-sectional view of the printed article designated D-D in FIG. 2C according to various aspects and embodiments of the present disclosure.

FIG. 3A illustrates a top-down view of an example printed composite article with certain internal components visible according to various aspects and embodiments of the present disclosure.

FIG. 3B illustrates a bottom-up view of the printed composite article shown in FIG. 3A with certain internal components visible according to various aspects and embodiments of the present disclosure.

FIG. 3C illustrates the cross-sectional view of the printed composite article designated E-E in FIG. 3A according to various aspects and embodiments of the present disclosure.

FIG. 3D illustrates the cross-sectional view of the printed composite article designated F-F in FIG. 3C with certain internal components visible according to various aspects and embodiments of the present disclosure.

FIG. 4 illustrates an example additive manufacturing process according to various aspects and embodiments of the present disclosure.

FIG. 5A illustrates a perspective view of an example additive manufacturing environment according to various aspects and embodiments of the present disclosure.

FIG. 5B illustrates a side view of the DIW printing environment shown in FIG. 5A according to various aspects and embodiments of the present disclosure.

### DETAILED DESCRIPTION

Liquid metal (LM) elastomer composites offer promising potential in soft robotics, wearable electronics, and human-machine interfaces. Direct ink write (DIW) three-dimensional (3D) printing offers a versatile manufacturing technique capable of precise control over LM microstructures, yet challenges such as interfilament void formation in multilayer structures impact material performance. In a DIW printing process, three key parameters—nozzle height, extrusion rate, and nondimensionalized nozzle velocity—can be selected to influence the geometry of a printed filament. It has been determined that nozzle height and velocity predominantly influence such printed filament geometry. The nozzle height primarily dictates the aspect ratio of the filament and the formation of voids. A threshold nozzle print height based on filament geometry has also been identified. Significant surface roughness occurs below the threshold height and the ink fractures above it.

DIW is a versatile additive manufacturing method. It enables the fabrication of intricate structures by extrusion of high-viscosity fluids through a fine nozzle to create fully dense and porous solids, high aspect ratio structures, and spanning elements for diverse fields including soft robotics, stretchable electronics, and biomedical applications. The materials suitable for DIW span a diverse set of viscoelastic inks including highly loaded suspensions and emulsions, conductive pastes, and elastomers. During DIW, ink composition and print processing parameters can be tailored to achieve precise control of filament microstructure across different length scales, which directly influences various properties of a printed object. Recently, shear-induced alignment has been demonstrated during printing of a variety of ink compositions and fillers such as LM microdroplets, liquid crystal molecules, and high-aspect ratio fibers. The alignment of the fillers follow the prescribed motion of the printer's nozzle and leads to programmed anisotropic functional properties. For functional emulsion inks consisting of spherical LM microdroplets dispersed in a prepolymer matrix, both the ink properties and the printing process parameters are crucial for controlling LM microdroplet shape and orientation during DIW alignment. This is in contrast to most other DIW printing applications, where a single set of printing parameters is adopted to minimize the void content and rarely changed during the printing process. For DIW printing of LM emulsions, the influence of the printing parameters on the dimensional accuracy and void content is not used by or included in existing printing systems or processes. Regardless of application, factors such as surface quality, dimensional accuracy, and defect content can directly impact mechanical and functional properties of a printed structure.

The occurrence of voids within printed structures is a common issue in DIW. These unintended voids can arise from entrapment of air during the extrusion process, which can be influenced by the cross-sectional shape of the filament or ink fracture. For LM emulsion inks, these void structures impact functional properties such as thermal conductivity, electrical conductivity, dielectric permittivity, and acoustic impedance of a printed sample. To achieve optimal functionality of a printed structure, the relationship between print processing parameters, resulting void content, and material and structural properties is systematically described in examples herein.

The intentional introduction of voids can also have a positive effect from a structural perspective. Voids can be utilized to decrease the density of a material and have a significant impact on the mechanical response. Polymeric foams are often manufactured using methods that involve foaming agents, gas dissolution, or sacrificial templates to produce complex 3D porous structures. However, achieving different porosities or functionally graded foams through these means often requires modifications to the material composition or template design. Recent advancements, including microfluidic techniques and direct bubble writing, offer promising approaches for controlling the structure and porosity of polymeric foams. However, while these methods afford high tunability, they are limited to low-viscosity fluids. In addition, all existing methods would result in primarily spherical LM microdroplets with limited control over LM microstructure.

The embodiments of the present disclosure provide a solution to the above-described problems related to DIW printing in general and DIW printing of LM emulsions in the form of a DIW process for controlling both material architecture and LM microstructure of a printed article. Leveraging the aforementioned threshold nozzle print height below which significant surface roughness occurs and ink fracture occurs above, the embodiments include or can be implemented to create porous structures with at least one of tunable stiffness or programmable LM microstructure. These porous architectures exhibit reduced density and greater thermal conductivity in many examples compared to cast samples. When used as a dielectric in a soft capacitive sensor in some cases, these porous architectures display high sensitivity (e.g., gauge factor=9.0), as permittivity increases with compressive strain. These example results demonstrate the capability of the embodiments to simultaneously manipulate LM microstructure and geometric architecture in LM elastomer composites through precise control of print parameters, while maintaining geometric fidelity in a printed design.

Some embodiments include a DIW additive manufacturing method for creating both fully dense solids and porous foams using high viscosity LM emulsion inks. This method enables the creation of printed structures in many cases with programmable porosity and control over LM droplet microstructure using a single ink formulation extruded through a single nozzle. In some examples, the functional emulsion ink consists of spherical LM microdroplets (e.g., 200 μm diameter and 50% by volume) embedded within a high-viscosity silicone prepolymer matrix. After printing, the composite in many cases is cured into a soft and highly extensible elastomeric composite. Some embodiments include controlling printing process conditions to transform initially spherical LM droplets into highly elongated and oriented ellipsoids in single-layer and multi-layer structures. Other embodiments include controlling at least one of nondimensional nozzle speed V*, nozzle height H, or extrusion rate C to influence geometry of a resultant filament, including width, height, cross-sectional area, and aspect ratio.

By analyzing printed filament geometry, the embodiments can be implemented to identify optimal parameters for fabricating dense multilayered structures and high aspect ratio features with improved surface quality and minimal internal defects in some cases. However, because of die swelling and ink spreading post-deposition, which depends on printing conditions, a programmed layer height and resulting printed filament height are different in many examples. This discrepancy can result in increased surface roughness or the formation of voids. To address this, some embodiments include adjusting a programmed layer height based on a measured printed filament geometry to ensure creation of high-quality multilayer structures while retaining control over LM droplet microstructures in the multilayer structures. Under specific printing conditions in some examples, a printed filament can become discontinuous despite a continuous nozzle path. As nozzle speed and height increase in many cases, an extruded ink thins and eventually becomes unstable due to the Plateau-Rayleigh instability and poor adhesion to a substrate or previous layer, resulting in discontinuous segments. The embodiments leverage this instability and fracture behavior of viscoelastic emulsion ink in many examples to allow for tailoring of a relative porosity of a structure and creating functionally graded foam structures without modifying ink formulation itself. This unique combination of DIW control and functional emulsion inks included in and used by the embodiments offers a rapid and versatile approach to controlling architecture and microstructure of various pure or single material and composite 3D printed articles such as LM elastomer composites in some cases.

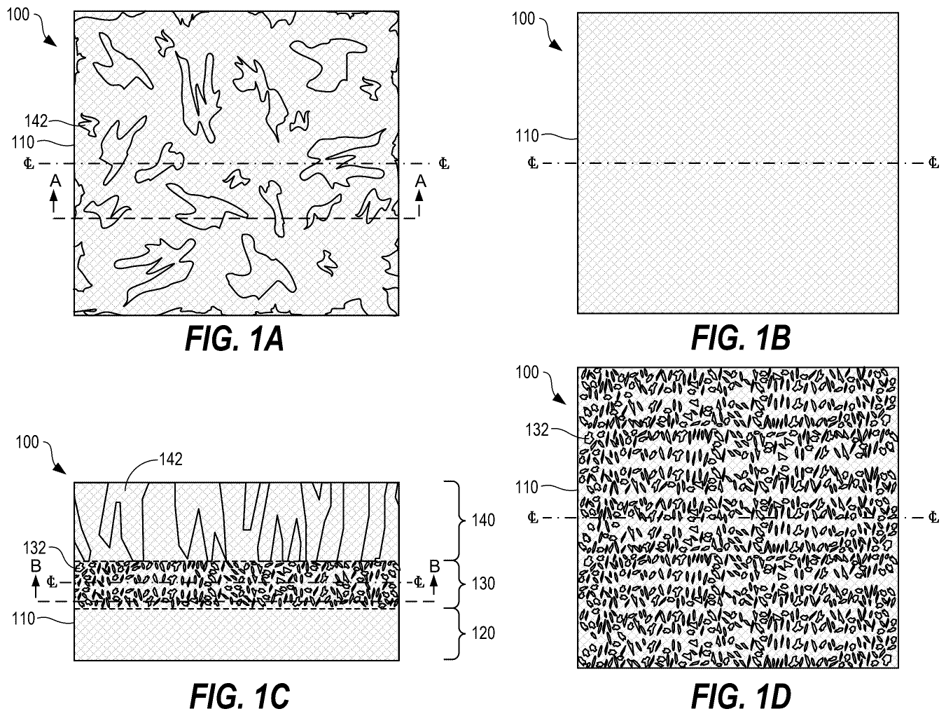

Turning now to the figures, FIG. 1A illustrates a top-down view of an example printed article 100 according to various aspects and embodiments of the present disclosure. FIG. 1B illustrates a bottom-up view of the printed article 100 according to various aspects and embodiments of the present disclosure. FIG. 1C illustrates the cross-sectional view of the printed article 100 designated A-A in FIG. 1A according to various aspects and embodiments of the present disclosure. FIG. 1D illustrates the cross-sectional view of the printed article 100 designated B-B in FIG. 1C according to various aspects and embodiments of the present disclosure.

The printed article 100 is a representative example embodiment of a functionally graded pure or single material 3D printed article having nonporous regions and porous regions. The concepts described herein can be extended to use with a range of 3D printed articles of different types, styles, components, and configurations, however. For instance, the embodiments described herein can be extended to use with various types of functionally graded 3D printed composite articles in some cases. The printed article 100 can be embodied and implemented as a functionally graded polymer or elastomer foam having nonporous and porous regions in some cases. The printed article 100 can be fabricated by performing an additive manufacturing process such as a 3D direct ink write printing process described in examples herein. In some cases, the printed article 100 can be at least one of embedded in or formed on a surface of one or more of a rigid, flexible, stretchable, or elastic substrate.

The printed article 100 is not drawn to any particular scale or size in the drawings. The shape, size, proportion, and other characteristics of the printed article 100 can vary as compared to that shown. For example, the printed article 100 can have a different number, porosity, or configuration of nonporous or porous regions compared to that shown, and other variations are within the scope of the examples described herein. Additionally, one or more of the parts or components of the printed article 100, as illustrated in the drawings and described herein, can be omitted in some cases. The printed article 100 can also include other parts or components that are not illustrated.

Referring among FIGS. 1A to 1D, the printed article 100 in the example shown includes a polymer matrix 110 having a nonporous region or layer 120, a first porous region or layer 130, and a second porous region or layer 140. The porous layer 130 is adjacent to and at least partly integrated with or coupled to the nonporous layer 120 and the porous layer 140 is adjacent to and at least partly integrated with or coupled to the porous layer 130 in this example. Individually and collectively the porous layers 130, 140 at least partly define and form a porous region on the printed article 100 and the nonporous layer 120 at least partly defines and forms a nonporous region on the printed article 100. The printed article 100 and the polymer matrix 110 share a common longitudinal axis or centerline (℄) shown in this example.

The polymer matrix 110 and each of its regions or layers such as the nonporous layer 120 and the porous layers 130, 140 can be embodied as or include pure or pristine polymer material formed from a pure or pristine prepolymer material in many examples. The polymer matrix 110, the nonporous layer 120, and the porous layers 130, 140 can each be embodied as or include pure or pristine polymer material formed from a relatively high-viscosity silicone prepolymer material or another viscoelastic material in some examples. The polymer matrix 110, the nonporous layer 120, and the porous layers 130, 140 can each be embodied as or include a single, pristine, pure, or homogeneous polymer material or another material formed from a high-viscosity liquid such as a pure or single viscoelastic ink formulation having a relatively high-viscosity in other cases. As referenced herein, a “pristine” or “pure” polymer material or “matrix” can refer to one having only a single type of polymer material or ink formulation with all other materials being omitted.

The nonporous layer 120 can be embodied as or include a layer of nonporous polymer material (e.g., solid or fully dense polymer material). For instance, the nonporous layer 120 can be formed such that all internal and surface voids and defects are omitted using a pure polymer ink formulation and a direct ink write printing process described in examples herein.

The porous layers 130, 140 can each be embodied as or include a layer of porous polymer material. For instance, the porous layers 130, 140 can each be formed such that it includes pores, voids, pockets, channels, grooves, or other internal or surface voids or defects using a pure polymer ink formulation and a direct ink write printing process described in examples herein. The porous layer 130 includes a plurality of pores 132 and the porous layer 140 includes a plurality of pores 142 in the example shown. Only a single pore 132, 142 is denoted in the figures for clarity.

The porosity, pore volume, or void density of each of the porous layers 130, 140 is defined at least in part by the size, geometry, and number of their respective pores 132, 142. In the example shown, the porous layer 130 is embodied as or includes a layer of porous polymer material having a first porosity and the porous layer 140 is embodied as or includes a layer of porous polymer material having a second porosity that is different from that of the first porosity of the porous layer 130. In other examples, the porous layers 130, 140 can be embodied as or include layers of porous polymer material having the same porosity.

In the example shown, each of the porous layers 130, 140 is embodied as or includes a layer of porous polymer material having a uniform porosity in at least one direction relative to the longitudinal centerline ¢ of the printed article 100. For instance, each of the porous layers 130, 140 is embodied as or includes a layer of porous polymer material having a uniform porosity in at least one of a longitudinal (e.g., parallel) direction or a radial (e.g., perpendicular) direction relative to the longitudinal centerline ¢. In some cases, each of the porous layers 130, 140 can have the same uniform porosity in at least one direction relative to the longitudinal centerline ¢. In other cases, each of the porous layers 130, 140 can have a different uniform porosity in at least one direction relative to the longitudinal centerline ¢.

In other examples, one or both of the porous layers 130, 140 can be embodied as or include a layer of porous polymer material having a variable or graded porosity in at least one direction relative to the longitudinal centerline ¢ of the printed article 100. For instance, one or both of the porous layers 130, 140 can be embodied as or include a layer of porous polymer material having an increasing porosity or a decreasing porosity in at least one of a longitudinal (e.g., parallel) direction or a radial (e.g., perpendicular) direction relative to the longitudinal centerline ¢. In another example, the porous layers 130, 140 can each be embodied as or include a layer of porous polymer material having a graded porosity that is oppositely graded compared to a graded porosity of the other porous layer 130, 140 in at least one direction (e.g., a longitudinal or radial direction) relative to the longitudinal centerline ℄ of the printed article 100. For instance, the porous layer 130 can be embodied as or include a layer of porous polymer material having a graded porosity that increases in porosity in a longitudinal or radial direction relative to the longitudinal centerline ℄ of the printed article 100 in some cases. In these examples, the porous layer 140 can be embodied as or include a layer of porous polymer material having a graded porosity that decreases in porosity in the same longitudinal or radial direction relative the longitudinal centerline ℄ of the printed article 100. In the example shown, each of the porous layers 130, 140 includes a layer of porous polymer material having a different porosity compared to that of the other porous layer 130, 140, and together the porous layers 130, 140 at least partly define and form a graded porosity in the polymer matrix 110 in a radial or perpendicular direction relative to the longitudinal centerline ℄ of the printed article 100.

The printed article 100 can be formed into a variety of geometries and dimensions. The printed article 100 is formed into an approximately square or rectangular shape in the example shown, although it may be formed to another shape in some cases. In some examples, the printed article 100 may include at least one additional or different nonporous layer 120 or porous layer 130, 140. In some cases, at least one of the nonporous layer 120 or the porous layers 130, 140 can be omitted from the printed article 100.

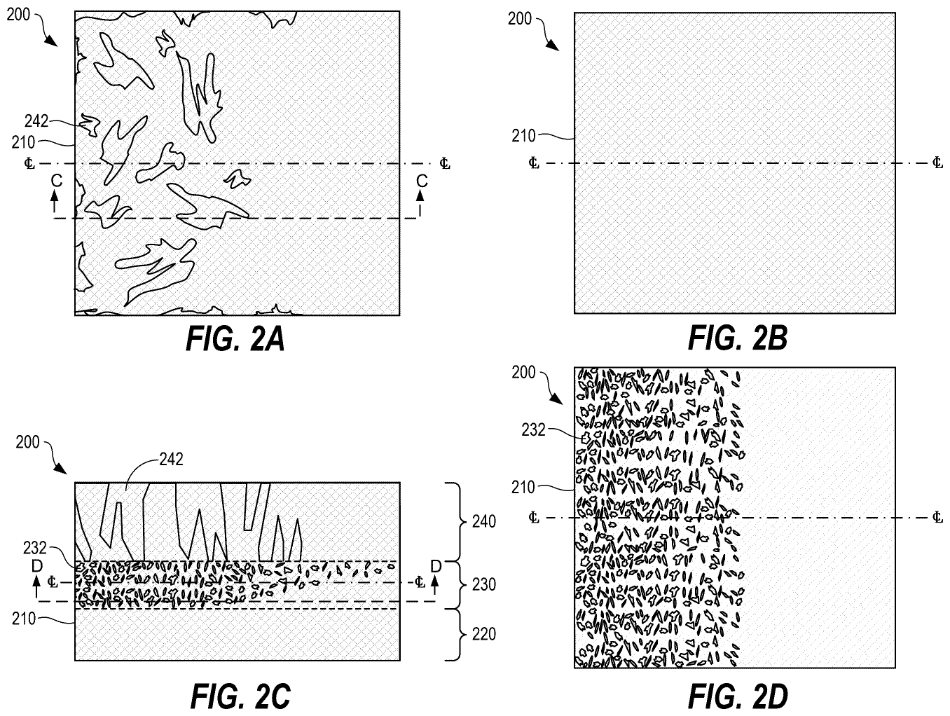

FIG. 2A illustrates a top-down view of another example printed article 200 according to various aspects and embodiments of the present disclosure. FIG. 2B illustrates a bottom-up view of the printed article 200 according to various aspects and embodiments of the present disclosure. FIG. 2C illustrates the cross-sectional view of the printed article 200 designated C-C in FIG. 2A according to various aspects and embodiments of the present disclosure. FIG. 2D illustrates the cross-sectional view of the printed article 200 designated D-D in FIG. 2C according to various aspects and embodiments of the present disclosure.

The printed article 200 is an example alternative embodiment of the printed article 100 described herein with reference to FIGS. 1A to 1D. The printed article 200 can include or more of the same or similar materials, components, structure, attributes, and functional ability as that of the printed article 100. The printed article 200 includes at least one layer of porous polymer material having a variable or graded porosity in at least one direction relative to a longitudinal centerline ¢ of the printed article 200.

The printed article 200 is another representative example embodiment of a functionally graded pure or single material 3D printed article having nonporous regions and porous regions. The concepts described herein can be extended to use with a range of 3D printed articles of different types, styles, components, and configurations, however. For instance, the embodiments described herein can be extended to use with various types of functionally graded 3D printed composite articles in some cases. The printed article 200 can be embodied and implemented as a functionally graded polymer or elastomer foam having nonporous and porous regions in some cases. The printed article 200 can be fabricated by performing an additive manufacturing process such as a 3D direct ink write printing process described in examples herein. In some cases, the printed article 200 can be at least one of embedded in or formed on a surface of one or more of a rigid, flexible, stretchable, or elastic substrate.

The printed article 200 is not drawn to any particular scale or size in the drawings. The shape, size, proportion, and other characteristics of the printed article 200 can vary as compared to that shown. For example, the printed article 200 can have a different number, porosity, or configuration of nonporous or porous regions compared to that shown, and other variations are within the scope of the examples described herein. Additionally, one or more of the parts or components of the printed article 200, as illustrated in the drawings and described herein, can be omitted in some cases. The printed article 200 can also include other parts or components that are not illustrated.

Referring among FIGS. 2A to 2D, the printed article 200 in the example shown includes a polymer matrix 210 having a nonporous region or layer 220, a first porous region or layer 230, and a second porous region or layer 240. The porous layer 230 is adjacent to and at least partly integrated with or coupled to the nonporous layer 220 and the porous layer 240 is adjacent to and at least partly integrated with or coupled to the porous layer 230 in this example. Individually and collectively the porous layers 230, 240 at least partly define and form a porous region on the printed article 200 and the nonporous layer 220 at least partly defines and forms a nonporous region on the printed article 200. The printed article 200 and the polymer matrix 210 share a common longitudinal axis or centerline (℄) shown in this example.

The polymer matrix 210 and each of its regions or layers such as the nonporous layer 220 and the porous layers 230, 240 can be embodied as or include pure or pristine polymer material formed from a pure or pristine prepolymer material or other viscoelastic material in many examples. The polymer matrix 210, the nonporous layer 220, and the porous layers 230, 240 can each be embodied as or include pure or pristine polymer material formed from a relatively high-viscosity silicone prepolymer material in some examples. The polymer matrix 210, the nonporous layer 220, and the porous layers 230, 240 can each be embodied as or include a single, pristine, pure, or homogeneous polymer material or another material formed from a high-viscosity liquid such as a pure or single viscoelastic ink formulation having a relatively high-viscosity in other cases.

The nonporous layer 220 can be embodied as or include a layer of nonporous polymer material (e.g., solid or fully dense polymer material). For instance, the nonporous layer 220 can be formed such that all internal and surface voids and defects are omitted using a pure polymer ink formulation and a direct ink write printing process described in examples herein.

The porous layers 230, 240 can each be embodied as or include a layer of porous polymer material in many cases. For instance, the porous layers 230, 240 can each be formed such that it includes pores, voids, pockets, channels, grooves, or other internal or surface voids or defects using a pure polymer ink formulation and a direct ink write printing process described in examples herein. The porous layer 230 includes a plurality of pores 232 and the porous layer 240 includes a plurality of pores 242 in the example shown. Only a single pore 232, 242 is denoted in the figures for clarity.

The porosity, pore volume, or void density of each of the porous layers 230, 240 is defined at least in part by the size, geometry, and number of their respective pores 232, 242. In the example shown, the porous layer 230 is embodied as or includes a layer of porous polymer material having a first porosity and the porous layer 240 is embodied as or includes a layer of porous polymer material having a second porosity that is different from that of the first porosity of the porous layer 230. In other examples, the porous layers 230, 240 can be embodied as or include layers of porous polymer material having the same porosity.

In the example shown, each of the porous layers 230, 240 is embodied as or includes a layer of porous polymer material having a variable or graded porosity in at least one direction relative to the longitudinal centerline ℄ of the printed article 200. For instance, each of the porous layers 230, 240 is embodied as or includes a layer of porous polymer material having an increasing porosity or a decreasing porosity in a longitudinal (e.g., parallel) direction and a radial (e.g., perpendicular) direction relative to the longitudinal centerline ℄ of the printed article 200. In the example shown, each of the porous layers 230, 240 includes a layer of porous polymer material having a different graded porosity compared to that of the other porous layer 230, 240. In some cases, each of the porous layers 230, 240 can have the same graded porosity in at least one direction relative to the longitudinal centerline ℄. In the example shown, each of the porous layers 230, 240 at least partly defines and forms a graded porosity in the polymer matrix 210 in both a longitudinal direction and a radial direction relative to the longitudinal centerline ℄ of the printed article 200.

In some examples, the porous layers 230, 240 can each be embodied as or include a layer of porous polymer material having a graded porosity that is oppositely graded compared to a graded porosity of the other porous layer 230, 240 in at least one direction (e.g., a longitudinal or radial direction) relative to the longitudinal centerline ℄ of the printed article 200. For instance, the porous layer 230 can be embodied as or include a layer of porous polymer material having a graded porosity that increases in porosity in a certain longitudinal or radial direction relative to the longitudinal centerline ℄ of the printed article 200 in some cases. In these examples, the porous layer 240 can be embodied as or include a layer of porous polymer material having a graded porosity that decreases in porosity in the same longitudinal or radial direction relative the longitudinal centerline ℄ of the printed article 200.

The printed article 200 can be formed into a variety of geometries and dimensions. The printed article 200 is formed into an approximately square or rectangular shape in the example shown, although it may be formed to another shape in some cases. In some examples, the printed article 200 may include at least one additional or different nonporous layer 220 or porous layer 230, 240. In some cases, at least one of the nonporous layer 220 or the porous layers 230, 240 can be omitted from the printed article 200.

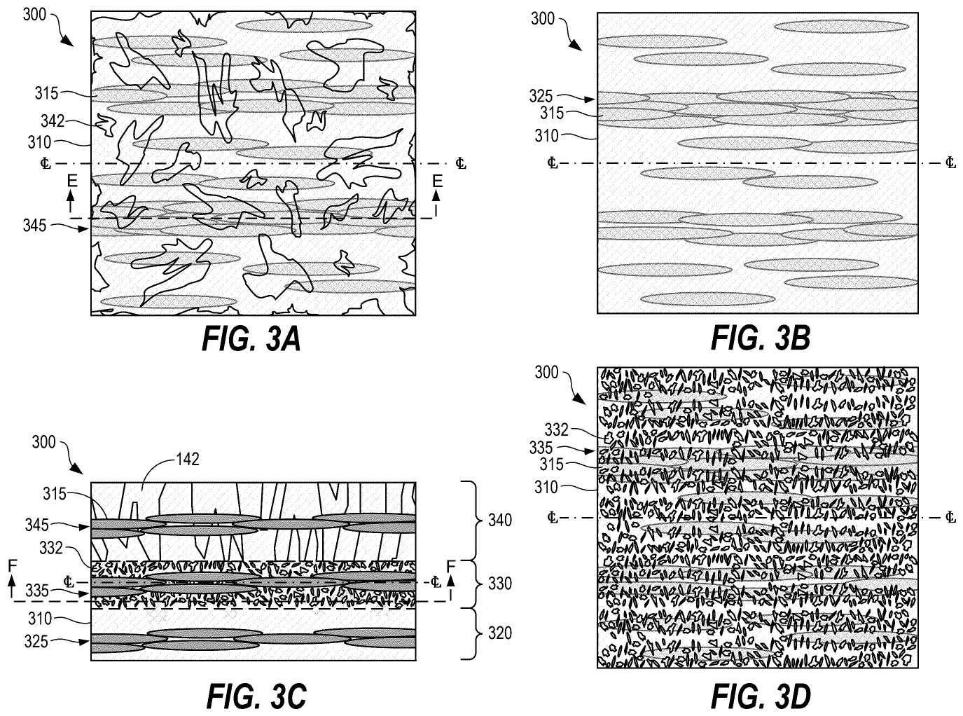

FIG. 3A illustrates a top-down view of an example printed composite article 300 with certain internal components visible according to various aspects and embodiments of the present disclosure. FIG. 3B illustrates a bottom-up view of the printed composite article 300 with certain internal components visible according to various aspects and embodiments of the present disclosure. FIG. 3C illustrates the cross-sectional view of the printed composite article 300 designated E-E in FIG. 3A according to various aspects and embodiments of the present disclosure. FIG. 3D illustrates the cross-sectional view of the printed composite article 300 designated F-F in FIG. 3C with certain internal components visible according to various aspects and embodiments of the present disclosure.

The printed composite article 300 is an example alternative embodiment of the printed article 100 described herein with reference to FIGS. 1A to 1D. The printed composite article 300 can include or more of the same or similar materials, components, structure, attributes, and functional ability as that of the printed article 100. The printed composite article 300 includes a polymer matrix having layers of porous and nonporous material and a plurality of liquid metal elements aligned with and coupled to one another within at least one of such porous or nonporous layers to form one or more conductive paths or networks at least partly through the printed composite article 300.

The printed composite article 300 is a representative example embodiment of a functionally graded LM polymer or elastomer composite 3D printed article having nonporous regions and porous regions. The concepts described herein can be extended to use with a range of 3D printed composite articles of different types, styles, components, configurations, and materials, however. For instance, the embodiments described herein can be extended to use with various types of functionally graded 3D printed pure material articles and composite articles in some cases. The printed composite article 300 can be embodied and implemented as a functionally graded polymer or elastomer foam having nonporous and porous regions with conductive elements such as liquid metal elements embedded in and at least partly forming a conductive path or network in at least one of such regions in some cases.

The printed composite article 300 is an example embodiment of a 3D printed, flexible (e.g., bendable, twistable), stretchable (e.g., elastic), and electrically and thermally conductive LM polymer or elastomer composite of the present disclosure. The printed composite article 300 can be 3D printed in some cases using a direct ink write printing process described in examples herein. The printed composite article 300 can be embodied and implemented as a heterogeneous structure having one or more insulating, dielectric, or conductive regions (e.g., electrically, thermally conductive regions). The conductive region of the printed composite article 300 in various examples can be embodied as or include at least one of an electrode, an electrical trace, an electrical contact pad, an electrical interconnect, or another electrically conductive element. The printed composite article 300 can be at least one of embedded in or formed on a surface of one or more of a rigid, flexible, stretchable, or elastic substrate in some cases. For instance, the printed composite article 300 can be at least one of embedded in or formed on a surface of one or more of a rigid, flexible, stretchable, or elastic substrate to couple one or more conductive elements (e.g., LEDs, sensors) to the substrate in some examples or to couple multiple conductive elements to one another in other examples.

The printed composite article 300 can be used to implement or at least partly embody various electronic components and devices for different applications such soft robotics or wearable electronics. For instance, the printed composite article 300 can be used to implement or at least partly embody at least one of a heat sink, a soft capacitive strain sensor, an energy harvesting devices, or another electronic component or device in some cases. The printed composite article 300 can be used to implement or at least partly embody a capacitor in some cases such as a parallel plate capacitor.

The printed composite article 300 is not drawn to any particular scale or size in the drawings. The shape, size, proportion, and other characteristics of the printed composite article 300 can vary as compared to that shown. For example, the printed composite article 300 can have a different number, porosity, or configuration of nonporous or porous regions or a different number, individual geometry, or collective configuration of conductive elements compared to that shown, and other variations are within the scope of the examples described herein. Additionally, one or more of the parts or components of the printed composite article 300, as illustrated in the drawings and described herein, can be omitted in some cases. The printed composite article 300 can also include other parts or components that are not illustrated.

Referring among FIGS. 3A to 3D, the printed composite article 300 in the example shown includes a polymer matrix 310 having a nonporous region or layer 320, a first porous region or layer 330, and a second porous region or layer 340. The porous layer 330 is adjacent to and at least partly integrated with or coupled to the nonporous layer 320 and the porous layer 340 is adjacent to and at least partly integrated with or coupled to the porous layer 330 in this example. Individually and collectively the porous layers 330, 340 at least partly define and form a porous region on the printed composite article 300 and the nonporous layer 320 at least partly defines and forms a nonporous region on the printed composite article 300. The printed composite article 300 and the polymer matrix 310 share a common longitudinal axis or centerline (℄) shown in this example.

The polymer matrix 310 and each of its regions or layers such as the nonporous layer 320 and the porous layers 330, 340 can be embodied as or include a conductive composite material formed from a pure or pristine prepolymer material or other viscoelastic material in some cases or from a prepolymer conductive composite material in other examples. The polymer matrix 310, the nonporous layer 320, and the porous layers 330, 340 can each be embodied as or include a conductive composite material formed from a relatively high-viscosity silicone prepolymer material in some examples or from a relatively high-viscosity viscoelastic emulsion ink in other examples. The polymer matrix 310, the nonporous layer 320, and the porous layers 330, 340 can each be embodied as or include a single, pristine, pure, or homogeneous polymer material or another material formed from a high-viscosity liquid such as a pure or single viscoelastic ink formulation having a relatively high-viscosity in some cases. In other examples, the polymer matrix 310, the nonporous layer 320, and the porous layers 330, 340 can each be embodied as or include a composite or heterogeneous LM polymer material or another conductive polymer composite material formed from a high-viscosity liquid such as a conductive viscoelastic emulsion ink formulation having a relatively high-viscosity in some cases.

The nonporous layer 320 can be embodied as or include a layer of pure or composite nonporous material (e.g., solid or fully dense material). For instance, the nonporous layer 320 can be formed such that all internal and surface voids and defects are omitted using a pure polymer ink formulation or a conductive viscoelastic emulsion ink formulation and a direct ink write printing process described in examples herein.

The porous layers 330, 340 can each be embodied as or include a layer of pure or composite porous material. For instance, the porous layers 330, 340 can each be formed such that it includes pores, voids, pockets, channels, grooves, or other internal or surface voids or defects using a pure polymer ink formulation or a conductive viscoelastic emulsion ink formulation and a direct ink write printing process described in examples herein. The porous layer 330 includes a plurality of pores 332 and the porous layer 340 includes a plurality of pores 342 in the example shown. Only a single pore 332, 342 is denoted in the figures for clarity.

The porosity, pore volume, or void density of each of the porous layers 330, 340 is defined at least in part by the size, geometry, and number of their respective pores 332, 342. In the example shown, the porous layer 330 is embodied as or includes a layer of pure or composite porous material having a first porosity and the porous layer 340 is embodied as or includes a layer of pure or composite porous material having a second porosity that is different from that of the first porosity of the porous layer 330. In other examples, the porous layers 330, 340 can be embodied as or include layers of pure or composite porous material having the same porosity.

In the example shown, each of the porous layers 330, 340 is embodied as or includes a layer of pure or composite porous material having a uniform porosity in at least one direction relative to the longitudinal centerline ℄ of the printed composite article 300. For instance, each of the porous layers 330, 340 is embodied as or includes a layer of pure or composite porous material having a uniform porosity in at least one of a longitudinal (e.g., parallel) direction or a radial (e.g., perpendicular) direction relative to the longitudinal centerline ℄. In some cases, each of the porous layers 330, 340 can have the same uniform porosity in at least one direction relative to the longitudinal centerline ℄. In other cases, each of the porous layers 330, 340 can have a different uniform porosity in at least one direction relative to the longitudinal centerline ℄.

In other examples, one or both of the porous layers 330, 340 can be embodied as or include a layer of pure or composite porous material having a variable or graded porosity in at least one direction relative to the longitudinal centerline ℄ of the printed composite article 300. For instance, one or both of the porous layers 330, 340 can be embodied as or include a layer of pure or composite porous material having an increasing porosity or a decreasing porosity in at least one of a longitudinal (e.g., parallel) direction or a radial (e.g., perpendicular) direction relative to the longitudinal centerline ℄. In another example, the porous layers 330, 340 can each be embodied as or include a layer of pure or composite porous material having a graded porosity that is oppositely graded compared to a graded porosity of the other porous layer 330, 340 in at least one direction (e.g., a longitudinal or radial direction) relative to the longitudinal centerline ℄ of the printed composite article 300. For instance, the porous layer 330 can be embodied as or include a layer of pure or composite porous material having a graded porosity that increases in porosity in a longitudinal or radial direction relative to the longitudinal centerline ℄ of the printed composite article 300 in some cases. In these examples, the porous layer 340 can be embodied as or include a layer of pure or composite porous material having a graded porosity that decreases in porosity in the same longitudinal or radial direction relative the longitudinal centerline ℄ of the printed composite article 300. In the example shown, each of the porous layers 330, 340 includes a layer of pure or composite porous material having a different porosity compared to that of the other porous layer 330, 340, and together the porous layers 330, 340 at least partly define and form a graded porosity in the polymer matrix 310 in a radial or perpendicular direction relative to the longitudinal centerline ℄ of the printed composite article 300.

The printed composite article 300 can include a plurality of conductive elements such as liquid metal elements embedded in one or more layers of porous or nonporous polymer material in the polymer matrix 310. In the example shown, the printed composite article 300 includes a plurality of LM elements 315 such as micro-scale sized liquid metal elements or droplets embedded in each of the nonporous layer 320 and the porous layers 330, 340 of the polymer matrix 310. Only a single conductive LM element 315 is denoted in the figures for clarity.

Individual elements among the LM elements 315 in each respective layer of the polymer matrix 310 in the example shown are aligned with and coupled to one another to form one or more conductive paths or networks at least partly through the layer. In this example, the nonporous layer 320 includes a plurality of LM elements 315 aligned with and coupled to one another to form one or more conductive paths or networks such as a conductive path 325 at least partly or entirely through the nonporous layer 320 as shown. The porous layer 330 in this example includes a plurality of LM elements 315 aligned with and coupled to one another to form one or more conductive paths or networks such as a conductive path 335 at least partly or entirely through the porous layer 330 as shown. The porous layer 340 in this example includes a plurality of LM elements 315 aligned with and coupled to one another to form one or more conductive paths or networks such as a conductive path 345 at least partly or entirely through the porous layer 340 as shown. In some examples, individual elements among the LM elements 315 in one or more layers of the polymer matrix 310 are aligned with and coupled to one another to form a uniform, continuous, contiguous, and omnipresent conductive path or network that propagates through the layer.

Individual elements among the LM elements 315 in the example shown have at least one of a same longitudinal geometry (e.g., elongated, semi-cylindrical, elliptical, needle-like), a same cross-sectional geometry (e.g., semi-round or circular, semi-elliptical, semi-square or rectangular), or a same aspect ratio relative to one another. In some cases, individual elements among the LM elements 315 can have at least one of a different longitudinal geometry, a different cross-sectional geometry, or a different aspect ratio relative to one another. For instance, the LM elements 315 in the conductive path 325 in the nonporous layer 320 can have at least one of a different longitudinal geometry, a different cross-sectional geometry, or a different aspect ratio relative to the LM elements 315 in at least one of the conductive paths 335, 345 in the porous layers 330, 340, respectively, in some cases. Individual elements among the LM elements 315 in the example shown have an elongated, semi-cylindrical, elliptical, or needle-like longitudinal geometry. In other examples, individual elements among the LM elements 315 can have a different geometry compared to what is shown such as a round, semi-round, circular, or semi-circular geometry.

The printed composite article 300 can be formed into a variety of geometries and dimensions. The printed composite article 300 is formed into an approximately square or rectangular shape in the example shown, although it may be formed to another shape in some cases. In some examples, the printed composite article 300 may include at least one additional or different nonporous layer 320 or porous layer 330, 340. In some cases, the printed composite article 300 may include at least one additional or different plurality of LM elements 315 embedded in at least one additional or different nonporous layer 320 or porous layer 330, 340 to form at least one additional or different conductive path or network 325, 335, 345, respectively, in one or more such layers. In some cases, at least one of the nonporous layer 320, the porous layers 330, 340, or the conductive paths 325, 335, 345 can be omitted from the printed composite article 300.

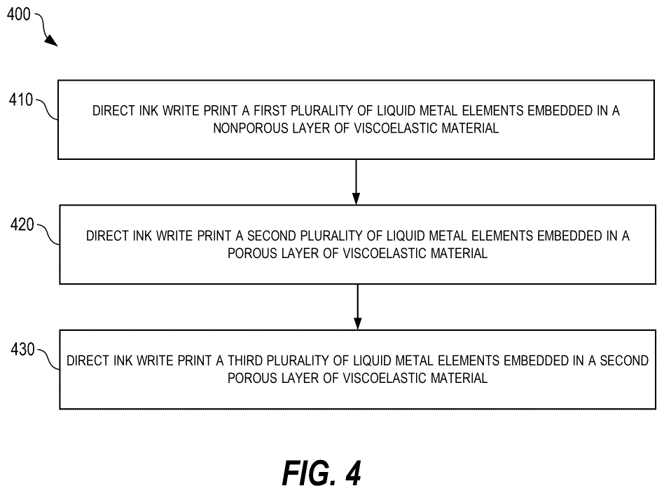

FIG. 4 illustrates an example additive manufacturing or direct ink write printing process 400 (or “DIW printing process 400”) according to various aspects and embodiments of the present disclosure. The DIW printing process 400 can be implemented in some examples to fabricate various direct ink write printed articles and direct ink write printed composite articles such as the printed article 100, the printed article 200, and the printed composite article 300 described herein with reference to FIGS. 1A to 3D. For instance, the DIW printing process 400 can be implemented to form the nonporous layers 120, 220 and the porous layers 130, 140, 230, 240 in the printed article 100, 200, respectively. In another example, the DIW printing process 400 can be implemented to form the conductive path 325 in the nonporous layer 320 and the conductive paths 335, 345 in the porous layers 330, 340, respectively, of the printed composite article 300.

At 410, the DIW printing process 400 includes direct ink write printing a first plurality of liquid metal elements embedded in a nonporous layer of viscoelastic material. For instance, the DIW printing process 400 can include direct ink write printing a first layer of viscoelastic emulsion ink at a first linear nozzle velocity and a first nozzle height relative to a first surface to form a first plurality of liquid metal elements embedded in a nonporous layer of viscoelastic material on the first surface. For example, the DIW printing process 400 can include direct ink write printing a first layer of viscoelastic emulsion ink at a first nozzle velocity V* and a reference nozzle height H_{c} as described in some examples herein to form the conductive path 325 of LM elements 315 embedded in the nonporous layer 320 of the printed composite article 300.

At 420, the DIW printing process 400 includes direct ink write printing a second plurality of liquid metal elements embedded in a porous layer of viscoelastic material. For instance, the DIW printing process 400 can include direct ink write printing a second layer of viscoelastic emulsion ink at a second linear nozzle velocity and a second nozzle height relative to a second surface to form a second plurality of liquid metal elements embedded in a porous layer of viscoelastic material on the second surface. For example, the DIW printing process 400 can include direct ink write printing a second layer of viscoelastic emulsion ink at a same or a different nozzle velocity V* compared to that used at 410 and a first nozzle height H₁ that is higher than the reference nozzle height H_{c} used at 410 as described in some examples herein to form the conductive path 335 of LM elements 315 embedded in the porous layer 330 of the printed composite article 300.

At 430, the DIW printing process 400 includes direct ink write printing a third plurality of liquid metal elements embedded in a second porous layer of viscoelastic material. For instance, the DIW printing process 400 at 430 can include direct ink write printing a third layer of viscoelastic emulsion ink at a third linear nozzle velocity and a third nozzle height relative to a third surface to form a third plurality of liquid metal elements embedded in a second porous layer of viscoelastic material on the third surface. For example, the DIW printing process 400 at 430 can include direct ink write printing a third layer of viscoelastic emulsion ink at a same or a different nozzle velocity V* compared to that used at 410 and 420 and a second nozzle height H₂ that is higher than each of the reference nozzle height He used at 410 and the first nozzle height H/used at 420 as described in some examples herein to form the conductive path 345 of LM elements 315 embedded in the porous layer 340 of the printed composite article 300.

In another example, the DIW printing process 400 at 430 can include direct ink write printing a third layer of viscoelastic emulsion ink at a same or a different nozzle velocity V* compared to that used at 410 and 420 and a second nozzle height H₂ that is higher than the reference nozzle height H_{c} used at 410 but lower than the first nozzle height H₁ used at 420 as described in some examples herein to form a conductive path of LM elements 315 embedded in a relatively less porous layer of the printed composite article 300 compared to the porous layer formed at 420.

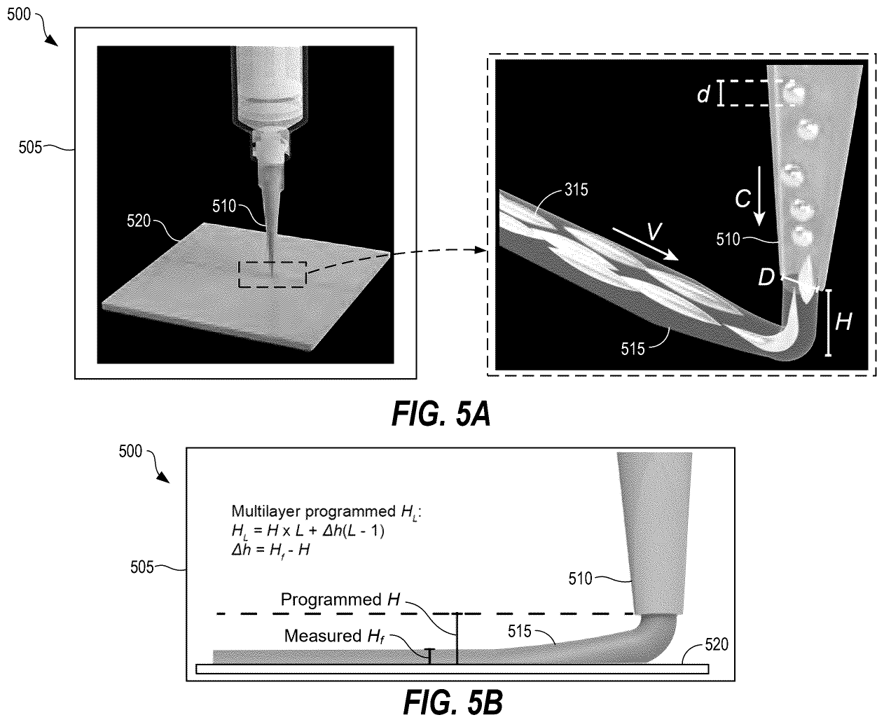

FIG. 5A illustrates a perspective view of an example additive manufacturing or direct ink write printing environment 500 (or “DIW printing environment 500”) according to various aspects and embodiments of the present disclosure. FIG. 5B illustrates a side view of the DIW printing environment 500 according to various aspects and embodiments of the present disclosure.

The DIW printing environment 500 can be used to implement the DIW printing process 400 in some examples to fabricate various direct ink write printed articles and direct ink write printed composite articles such as the printed article 100, the printed article 200, and the printed composite article 300 described herein with reference to FIGS. 1A to 3D. For instance, the DIW printing environment 500 can be used to implement the DIW printing process 400 to form the nonporous layers 120, 220 and the porous layers 130, 140, 230, 240 in the printed article 100, 200, respectively. In another example, the DIW printing environment 500 can be used to implement the DIW printing process 400 to form the conductive path 325 in the nonporous layer 320 and the conductive paths 335, 345 in the porous layers 330, 340, respectively, of the printed composite article 300.

Referring among FIGS. 5A and 5B, the DIW printing environment 500 in the example shown includes an additive manufacturing or direct ink write printing device 505 (or “DIW printing device 505”) having a nozzle 510 with a discharge diameter D. The nozzle 510 is operable to extrude various types of viscoelastic inks such as a viscoelastic emulsion ink 515 onto a surface 520 in this example. The viscoelastic emulsion ink 515 in the example shown includes conductive LM elements or droplets that initially have a circular or semi-circular geometry and diameter d before the viscoelastic emulsion ink 515 is extruded from the nozzle 520 at a nozzle extrusion velocity C. As described in examples herein, the circular geometry of the conductive LM elements can transform to an elongated, cylindrical, or needle-like geometry when the viscoelastic emulsion ink 515 is extruded from the nozzle 510 at a certain programmed nozzle height H and linear velocity V. For instance, the conductive LM elements can transform to the LM elements 315 in some cases when the viscoelastic emulsion ink 515 is extruded from the nozzle 510 at a certain programmed nozzle height H and linear velocity V.

To determine a programmed nozzle height H and linear velocity V combination that causes such a geometric transformation of the LM elements, the DIW printing device 505 can be used in some cases to iteratively print multiple layers of the viscoelastic emulsion ink 515 onto the surface 520 or previously printed layers at different programmed nozzle height H and linear velocity V combinations. In some examples, an offset Δh can be employed during a DIW print process as shown in FIG. 5B to tune at least one of a microstructure or geometry of LM elements in the viscoelastic emulsion ink 515 or a printed geometry of the viscoelastic emulsion ink 515. The offset Δh is a difference between a measured filament height H_{f} and a programmed layer height H, (e.g., Δh=H_{f}−H). Upon determining a desired geometry such as an elongated geometry for the LM elements 315 has been achieved, the DIW printing device 505 can be used to tune a printed porosity of the viscoelastic emulsion ink 515 while maintaining the elongated geometry of the LM elements 315. For instance, by maintaining a certain linear nozzle velocity V used to form the LM elements 315 and altering the programmed nozzle height H as described further herein, the DIW printing device 505 can be used to print nonporous and porous layers of the viscoelastic emulsion ink 515 with the LM elements 315 embedded in such layers. Upon curing, these nonporous and porous layers of the viscoelastic emulsion ink 515 having the LM elements 315 can transform into the nonporous layer 320 and the porous layers 330, 340 having the conductive paths 325 and 335, 345, respectively.

When implementing the DIW printing process 400 using the DIW printing device 505 in some examples herein, a viscoelastic emulsion ink formulation 515 can be extruded through the nozzle 510 at a certain H and V* to form elongated LM droplets such as the conductive paths 325, 335, 345 in a printed filament. In some examples, the DIW printing device 505 can be embodied and implemented at least in part as a mechanically driven syringe pump that can extrude a LM emulsion ink from a nozzle of a syringe at a specified extrusion speed C while the nozzle moves laterally along a substrate at a specified lateral velocity V and at a specified height H. The shape and orientation of LM microdroplets in the viscoelastic emulsion ink 515 can be controlled by adjusting printing process parameters such as a nondimensionalized nozzle velocity V* and nozzle height H, as well as ink properties such as LM droplet size and ink viscosity. The viscoelastic emulsion ink 515 can be formulated in some examples with a relatively high viscosity and large LM microdroplet size (e.g., 200 micrometers (μm) diameter, 50% by volume) to promote the formation of elongated LM microdroplets with relatively high aspect ratios.

To investigate the effect of printing process parameters V*, H, and C on filament geometry, laser profilometry can be performed in some cases to measure individual filament width, height, and cross-sectional area. These measurements can then be used in some examples to create space-filling solids printed in a uniformly aligned pattern and including 10 or more layers to investigate the effect of processing parameters on void formation and surface quality. During a DIW printing process, alternating layers can be at least partially cured using a heat gun in some examples. After printing, the surface quality of the samples can be visually examined using optical microscopy, and void content or porosity can be analyzed using microfocused X-ray computed tomography (XCT) in some cases.

Embodiments herein include controlling print process parameters during ink deposition to influence void formation and surface quality. Void content and poor surface quality can directly impact mechanical and functional properties of printed filaments and articles. A programmed layer height H can be systematically adjusted in some examples to achieve a desired external and internal print quality of a space-filling solid. Samples printed by the DIW printing device 505 at a low H relative to a deposition surface can exhibit ink accumulation on its edges and surface in some cases, resulting in samples with a reduced overall height and high surface roughness. This is likely attributed to die-swelling, where an extruded filament area exceeds nozzle area, which is common in viscoelastic inks. Conversely, samples printed by the DIW printing device 505 with the nozzle 510 at an elevated H relative to the surface 520 can include interfilament voids and high porosity in many examples due to ink spreading post-deposition and formation of discontinuities at higher V* and H. To address this, an offset Δh shown in FIG. 5B can be employed during a print process in some cases, where Δh is a difference between a measured filament height H_{f} and a programmed layer height H (e.g., Δh=H_{f}−H). Filament height can be measured by laser profilometry prior to printing multilayered structures in some examples. The programmed print height for multilayered structures can be defined by H×L+Δh (L−1) in many examples, where L is a layer being printed. A programmed layer height H_{L} can be systematically adjusted to achieve a desired external and internal print quality of a space-filling solid in many cases (e.g., as seen in FIG. 5B), thereby enabling fabrication of multilayer structures with minimal defects at any given H and V*.

A 3D DIW printer such as the DIW printing device 505 with a mechanically driven print head and the nozzle 510 can be used in some examples to investigate variations in filament geometry as a function of process parameters H, V*, and C. A LM emulsion ink such as the viscoelastic emulsion ink 515 can be printed at two different heights in some cases based on a reference nozzle height H_{c}=πD/4V*, where D represents nozzle diameter as shown in FIG. 5A. For instance, the viscoelastic emulsion ink 515 can be printed at a height 1.5×H_{c} above the reference nozzle height and at a height 0.9×H_{c} below the reference nozzle height. Printing below the reference nozzle height can cause a printed filament to squeeze and expand outward in many examples, as space between the nozzle 510 and the surface 520 is smaller than a volume of extruded material, assuming volume conservation within a flat cuboid shape. Conversely, printing above the reference nozzle height can cause a printed filament to maintain a rounded shape during extrusion, with ink spreading occurring post-deposition in many cases. In some cases, printing with the nozzle 510 at a lower height such as 200, 50, and 20 μm at V*=1, 6, and 12, respectively, can achieve maximum LM microdroplet elongation for a certain emulsion ink formulation. The V* is also a processing parameter that affects LM microstructure and filament geometry in some embodiments. An emulsion ink such as the viscoelastic emulsion ink 515 can be printed at V*=1, 6, and 12 in some cases, resulting in nine different combinations of H and V*. To study the effect of extrusion rate C on trace formation, three different values can be selected in some cases such as C=6.8, 5.0, and 2.5 millimeters per second (mm/s) for each H and V*. The profile of each filament can be imaged using laser profilometry in some examples.

The average filament width, normalized by the nozzle diameter D, was observed to be similar for all H and C tested in some examples and mainly influenced by V* due to the reduction of material being extruded per length. As V* increased in these examples from 1 to 12, a normalized width of a filament ranged from three times (3×) nozzle diameter to just slightly less than nozzle diameter. The data for all combinations of printing parameters in these examples suggests an average filament height, normalized by nozzle diameter, generally decreases as H decreases and V* increases. There were negligible changes observed in these examples with respect to C. It was observed that filament height can be reduced in some cases by 30% for V*=1 and 6, with smaller reductions observed for V*=12. The largest reduction of up 85% in height was observed in cases where V* increased from 1 to 12. For the processing parameters and ink properties used in these examples the extruded ink was compressed due to the H and then spread further post-deposition, which resulted in filament width being much greater than nozzle diameter. This relationship is illustrated in these examples by an average printed filament aspect ratio (H_{f}/W). Emphasizing a correlation between filament width and height, an inverse average printed filament aspect ratio (H_{f}/W)⁻¹ was determined in these examples to increase as H decreases and V* increases. There were negligible changes observed in these examples with respect to C. The average cross-sectional area was observed to decrease with increasing V* in these examples, which was determined to be due to a reduction of material being extruded per length.

There are negligible changes with respect to H and C in these examples. The relationship between a predicted and measured cross-sectional area can be determined in some cases. An extrusion rate used to calculate a predicted cross-sectional area in these examples can be empirically measured by calculating volume of material extruded in one minute. Measured extrusion rates can be lower than those calculated in some cases. Assuming incompressibility and volume conservation of an extruded ink, a predicted area of a printed filament can be calculated as A=π(D/2)²/V* in some cases.

The cross-sectional geometry of a printed filament is greatly influenced by V. and H in many examples. When using the DIW printing device 505 and the nozzle 510 to print at low H and high V* rectangular and wide filament shapes can be formed in some examples, whereas semicircular shapes can be formed in other examples by printing at high H and low V*. At low H, an ink can be pressed and forced to spread to the filament sides, resulting in high aspect ratios. At high V*, an ink can be stretched and thinned due to the high relative velocity between a print bed (V) and extruded ink (C), resulting in continuous but considerably smaller filaments compared to nozzle area. However, depending on the combination of H and V* in different examples, a printed filament may intermittently fracture, causing discontinuities.

Some examples include controlling printing parameters V* and H to tailor a microstructure of embedded LM droplets and cross-sectional geometry of a resulting filament. To examine their impact on the formation of interfilament voids and surface roughness, multilayered structures were created using the DIW printing device 505 and the nozzle 510 in some examples with extreme minimum and maximum H for V*=1, 6, and 12. Unless otherwise noted, all multilayer structures were created with C=2.5 mm/s in these examples to ensure the nozzle velocity remained within the printer's recommended X/Y velocity and trace spacing was set to 75% of the measured trace width. For structures created with low H across all V+, extruded ink was pressed and forced outwards, filling interfilament areas, which resulted in thin samples with minimal voids in some cases. However, die swelling caused a nozzle to accumulate extrudate, leading to material build-up and increased surface roughness in some examples. In contrast, at high H, extruded ink was not able to adhere to a previous layer in some cases, effectively resulting in thicker samples with significant void formation. At V*=1, a printed filament remained continuous in some examples, but formed a meandering pattern that deviated from a nozzle path, creating large voids. Meandering patterns are commonly observed at low V*≤1 and high H>D. For higher V* of 6 and 12, a filament in one example was stretched during deposition due to higher print speeds, leading to ink fracture, generating discontinuous filament segments.

To fabricate fully dense, high-quality multilayer structures for any given V* and H, an offset Δh can be applied to adjust print height of each layer based on measured filament height Systematically adjusting H of the nozzle 510 based on H_{f} can significantly reduce surface roughness and formation of interfilament voids in fully dense multilayer structures. The approach of the embodiments herein is effective regardless of a programmed H or V* required to tailor the microstructure of embedded LM droplets.

The LM droplet microstructure within multilayered structures can be analyzed in some cases using optical microscopy. The shape and orientation of LM droplets such as the LM elements 315 can be programmed in some examples by altering print parameters V* and H. At slower printing speeds of the nozzle 510, LM droplets in some examples can remain spherical, similar to emulsion ink. However, by increasing V* of the nozzle 510 and decreasing its H in other examples, LM droplets can transform from a spherical geometry to an elongated, needle-like geometry. Importantly, the 3D printing process embodiments of the present disclosure can be used to maintain control over a microstructure of LM droplets throughout an entire multilayer structure, even as porosity of the structure varies (e.g., as in the printed composite article 300). The porosity and pore size for each condition can be measured using XCT and 3D image analysis in some cases. The 3D printing process embodiments can be implemented to create fully dense and porous solids with programmable LM microstructures, which ultimately governs functional properties such as thermal conductivity.

Optical microscopy images and corresponding XCT porosity analysis of multilayer samples printed at V*=1, 6, and 12 without offset Δh was completed in some examples. Due to die swelling and ink spreading, some printed samples had defects. By utilizing Δh offset described in examples herein to account for die swelling and ink spreading, fully dense structures can be created with minimal defects, independent of H and V*. At low values of H, samples were observed to have high surface roughness in some cases. As H increased above the reference nozzle height H_{c}, the porosity was observed to increase. Comparison of thermal conductivity between pure elastomer and LM elastomer composites with 50% volume loading of LM in some examples indicated the printed samples in these cases, even with high porosity, have improved thermal conductivity as compared cast samples.

The effects of porosity on thermal conductivity of printed multilayer structures were also examined in some examples. The thermal conductivity of two cast samples and two printed samples was measured in one example using a transient plane source (TPS) method. The sensor was placed between two homogeneous samples in this example, which functions as both a heat source and temperature sensor. Two samples were cast with 0% and 50% volume loading of LM in one example and their respective thermal conductivities were k=0.15 and 1.45 watts per meter kelvin (W/m·K). These samples were compared to two samples that were 3D printed at V*=12 and H=0.08 in another example. Samples printed with the Δh offset described in examples herein had the highest thermal conductivity of k=3.3 W/m. K. Additionally, samples printed without the Δh offset exhibited a reasonably high thermal conductivity of k=2.13 W/m·K in other examples. This exceeded the thermal conductivity of a replica-molded sample with the same volume loading of LM, despite its considerably high porosity exceeding 30% in one example.

By simultaneously controlling the geometric structure and LM microstructure, the thermal conductivity increased nearly 50% in one example printed article while reducing the density of the printed article by over 30%. This illustrates the ability of the embodiments to control not only the thermal conductivity but also the material structure through the DIW 3D printing method described herein using a single emulsion ink and manufacturing system to optimize part-level properties.

To further demonstrate the versatility of the DIW 3D printing process, a series of self-supported, interdigitated millimeter-scale structures with high aspect ratios were fabricated in some examples. The interdigitated keys were printed at V*=1, 6, and 12 and H=0.25, 0.045, and 0.05 mm in some cases. Printing at lower V* in some examples tended to create keys with larger widths and lower aspect ratios (e.g., defined as key height/width) due to the low H and post-deposition spreading of the ink. By increasing V* to 6 and 12 in other examples, structures were created with sharper edges and more defined features. Due to the low H and spreading of the ink after deposition, the overall dimensions of the structures in some examples tended to be 1.2× to 1.6× larger than the expected key width, with a minimum lateral feature size of 1.25 mm. The aspect ratios for the structures printed at V*=1, 6, and 12 measured 0.561, 1.540, and 2.176, respectively, in some cases. This demonstrates the embodiments ability to allow for an ink to reliably flow through a fine nozzle, to create robust adhesion between printed layers, and ability to withstand curing without distortion in many cases. Refinement of key width and aspect ratio could be achieved in some examples by using a smaller nozzle diameter or increasing the number of printed layers. Thee intricately designed interdigitated structures included in or generated by the embodiments could be used for various applications, such as heat sinks, soft capacitive strain sensors, or energy harvesting devices for applications such as soft robotics or wearable electronics.

The DIW 3D printing strategy implemented by the embodiments enables novel functionalities beyond the limits of conventional DIW 3D printing. For example, the ability to print diverse complex patterns by using ink fracture can enable the creation of porous structures with tunable stiffness and programmable LM microstructure. While existing methods rely on a coiling instability with high-viscosity liquids to create porous structures, they are constrained by the significantly high nozzle height relative to the diameter of the print nozzle (H>>D=580 μm). The high H used by these existing methods limits the precise control over the microstructure of the LM microdroplets, as there is no observable change in microstructure due to extrusion through the nozzle. The embodiments of the present disclosure can print LM elastomer foams with tunable porosity in a reproducible and predictable manner through ink fracture in many examples. The porosity of a LM elastomer composite can be controlled by increasing H above the optimal value or reference nozzle height He described in examples herein, where the Δh=0. As H increases for V*=12 and the Δh offset is not used, the porosity increased in one example from 0.05% up to 33.40% and higher (e.g., 55% or more) in some cases. Importantly, even as H was increased above the optimal value, control over the microstructure of the LM microdroplets was maintained in many examples. The 3D printing process embodiments described herein can also be used to create functionally graded LM elastomer foams. The gradient structure in one example was varied or graded through the thickness by increasing H every 15 layers. By increasing H from 50 to 70 μm in increments of 10 μm, a porosity gradient spanning from 2.1% up to 51.3% can be achieved in various examples. This versatility enables tailoring of both the material properties and structure by controlling the print process parameters as described in examples herein.

A functionally graded LM elastomer foam described in some examples can be utilized to create a soft capacitive strain sensor in some cases by placing the dielectric foam between two electrodes. A functionally graded LM elastomer foam composite was created with a highly porous and nonporous section in a single print in one example. To create a fully dense region in this example, a sample was printed at V*=12 and an optimal H=0.05 mm for 30 layers. Next, to create a highly porous region in this example, H was increased to 70 μm (e.g., Δh=0). The electromechanical response of a resulting sensor was characterized in one example by performing cyclic loading at increasing levels of strain, from 10%, 20%, 30%, 40%, and 50%. After an initial loading cycle, the mechanical response of a printed sample in many cases is repeatable for the remaining cycles up to the maximum previous compressive strain with negligible hysteresis. Compared to a fully dense sample, printed samples of the present disclosure exhibit a relatively strong nonlinear response that increases sharply as a porous region of a sample is fully compressed.

In some embodiments, the porosity of the samples and that of their individual layers can be tailored by changing the print height (H), where the Δh offset described in examples herein is not used. In one example, a sample was printed at V*=12 and H was increased from 0.05 mm to 0.07 mm, resulting in relative increased or graded porosity within the sample.

Multilayered dielectrics described in examples herein such as the printed articles 100, 200 and the printed composite article 300 can enable capacitive sensors to have a high sensitivity and a large dynamic range simultaneously. The response of such devices increases non-linearly as a function of compressive strain in many cases. There is notable hysteresis in the system in many examples, as the baseline capacitance almost doubles from 10 to 50% strain. This indicates that increasing compressive strain causes irreversible changes in the structure of the material of many examples. The response is observed to be repeatable after the first cycle up to the maximum previous compressive strain with negligible hysteresis in many cases. For a parallel plate capacitor, the capacitance in some cases increases inversely proportional to the thickness (t) of the dielectric, C=ϵ₀ϵᵣA/t, where ϵ₀=8.885×10⁻¹² is the vacuum permittivity, ϵᵣ is the effective relative permittivity, and A is the planar area. The large difference between the theoretical parallel plate model and the sensor response is due to the positive piezopermittivity of the foam structure in some examples. As the LM foam is compressed in some cases, the low Er air is displaced, resulting in Er increasing with compressive strain. The gauge factor ((ΔC/C₀)/(Δd/d₀)) of the sensor ranges from 1.5 to 9 in some examples. At 50% strain in one example, the gauge factor of 9.0 is 800% higher than a fully dense sample, indicating high sensitivity and importance of the material structure. The soft and highly sensitive capacitive sensor embodiments in some examples herein could be used in applications such as human-machine interaction, soft robotics, and electronic skins that require the ability to sense a wide range of pressures.

Embodiments herein demonstrate the versatility of DIW 3D printing LM elastomer composites such as the printed articles 100, 200 and the printed composite article 300 by fabricating both fully dense solids and functionally graded foams across a wide range of print velocities and heights. To achieve on-demand programming of LM droplet microstructure (e.g., shape and orientation), the printing process conditions can be varied throughout the fabrication process in many examples, which directly influences the geometry of the filament and can lead to the formation of unintentional voids. Through systematic analysis of the interplay between the printing parameters and filament geometry, the embodiments identify and utilize optimal conditions for producing defect-free multilayered structures ranging from basic cubic forms to intricate interdigitated designs. Beyond a certain print height threshold, it was observed in many examples that a printed ink became discontinuous despite continuous nozzle movement. The embodiments exploit this instability and fracture behavior to create functionally graded foam structures with tailored porosity. By controlling the geometric structure and the LM microstructure, the embodiments demonstrate that the printed structures described herein have improved thermal conductivity for passive thermal management, permittivity that increases with sensor strain for enhanced sensitivity, and reduced material density as compared to cast samples. These advancements in manufacturing, material properties, and performance facilitated by the embodiments provide opportunities for integration into diverse applications such as soft robotics, wearable electronics, and human-machine interfaces, including tactile sensors, soft energy harvesting devices, and passive heat spreaders. The combination of on-demand control of geometric structure and LM microstructure implemented by the embodiments offers new opportunities for additive manufacturing and LM communities to create innovative materials, structures, and devices that possess a unique combination of functionalities.

The features, structures, or characteristics described above may be combined in one or more embodiments in any suitable manner, and the features discussed in the various embodiments are interchangeable, if possible. In the above description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable. Further, if a component is described as there being “at least one” of said component, it is understood that this may mean “one or more” of said component. Conversely, if a component is described as there being “one or more” of said component, it is understood that this may mean “at least one” of said component.

As referenced herein in the context of quantity, the terms “a” or “an” are intended to mean “at least one” and are not intended to imply “one and only one.” As referred to herein, the terms “include,” “includes,” and “including” are each intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, fluid coupling, thermal coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A printed composite article comprising:
a polymer matrix comprising a porous region; and
a plurality of liquid metal elements embedded in the polymer matrix.

2. The printed composite article of claim 1, wherein the porous region comprises porous polymer material having a uniform porosity in at least one direction relative to a longitudinal axis of at least one of the polymer matrix or the printed composite article.

3. The printed composite article of claim 1, wherein the porous region comprises porous polymer material having an increasing porosity or a decreasing porosity in at least one direction relative to a longitudinal axis of at least one of the polymer matrix or the printed composite article.

4. The printed composite article of claim 1, wherein the porous region comprises a first layer of porous polymer material and a second layer of porous polymer material adjacent to and at least partly integrated with or coupled to the first layer of porous polymer material.

5. The printed composite article of claim 4, wherein the first layer of porous polymer material and the second layer of porous polymer material have different porosities relative to one another.

6. The printed composite article of claim 4, wherein the first layer of porous polymer material and the second layer of porous polymer material have different uniform porosities compared to one another in at least one direction relative to a longitudinal axis of at least one of the polymer matrix or the printed composite article.

7. The printed composite article of claim 4, wherein the first layer of porous polymer material and the second layer of porous polymer material have oppositely graded porosities compared to one another in at least one direction relative to a longitudinal axis of at least one of the polymer matrix or the printed composite article.

8. The printed composite article of claim 1, wherein individual elements among the plurality of liquid metal elements are aligned with and coupled to one another at least partly through the porous region.

9. The printed composite article of claim 1, wherein the polymer matrix further comprises a nonporous region adjacent to and at least partly integrated with or coupled to the porous region.

10. The printed composite article of claim 9, wherein individual elements among the plurality of liquid metal elements are aligned with and coupled to one another at least partly through at least one of the porous region or the nonporous region.

11. The printed composite article of claim 1, wherein individual elements among the plurality of liquid metal elements have at least one of a same longitudinal geometry, a same cross-sectional geometry, or a same aspect ratio relative to one another.

12. A printed article comprising:
a polymer matrix comprising a nonporous region and a porous region adjacent to and at least partly integrated with or coupled to the nonporous region,
wherein the porous region comprises porous polymer material having an increasing porosity or a decreasing porosity in at least one direction relative to a longitudinal axis of at least one of the polymer matrix or the printed article.

13. The printed article of claim 12, wherein the porous region further comprises additional porous polymer material having a uniform porosity in at least one direction relative to the longitudinal axis of at least one of the polymer matrix or the printed article.

14. The printed article of claim 12, wherein the porous polymer material in the porous region comprises a first layer of porous polymer material adjacent to and at least partly integrated with or coupled to the nonporous region and a second layer of porous polymer material adjacent to and at least partly integrated with or coupled to the first layer of porous polymer material.

15. The printed article of claim 14, wherein the first layer of porous polymer material and the second layer of porous polymer material have different porosities relative to one another.

16. The printed article of claim 14, wherein the first layer of porous polymer material and the second layer of porous polymer material have different uniform porosities compared to one another in at least one direction relative to the longitudinal axis of at least one of the polymer matrix or the printed article.

17. The printed article of claim 14, wherein the first layer of porous polymer material and the second layer of porous polymer material have oppositely graded porosities compared to one another in at least one direction relative to the longitudinal axis of at least one of the polymer matrix or the printed article.

18. An additive manufacturing process comprising:
direct ink write printing a first layer of viscoelastic emulsion ink at a first linear nozzle velocity and a first nozzle height relative to a first surface to form a first plurality of liquid metal elements embedded in a nonporous layer of viscoelastic material on the first surface; and
direct ink write printing a second layer of viscoelastic emulsion ink at a second linear nozzle velocity and a second nozzle height relative to a second surface to form a second plurality of liquid metal elements embedded in a porous layer of viscoelastic material on the second surface, wherein:
the second nozzle height relative to the second surface is higher than the first nozzle height relative to the first surface; and
individual elements among each of the first plurality of liquid metal elements and the second plurality of liquid metal elements are formed to have at least one of a same longitudinal geometry, a same cross-sectional geometry, or a same aspect ratio relative to one another.

19. The additive manufacturing process of claim 18, further comprising:
direct ink write printing a third layer of viscoelastic emulsion ink at a third linear nozzle velocity and a third nozzle height relative to a third surface to form a third plurality of liquid metal elements embedded in a second porous layer of viscoelastic material on the third surface, wherein:
the first linear nozzle velocity, the second linear nozzle velocity, and the third linear nozzle velocity are a same linear nozzle velocity;
the third nozzle height relative to the third surface is higher than each of the first nozzle height relative to the first surface and the second nozzle height relative to the second surface; and
the second porous layer of viscoelastic material is formed to have a greater porosity relative to a porosity of the porous layer of viscoelastic material.

20. The additive manufacturing process of claim 18, further comprising:
direct ink write printing a third layer of viscoelastic emulsion ink at a third linear nozzle velocity and a third nozzle height relative to a third surface to form a third plurality of liquid metal elements embedded in a second porous layer of viscoelastic material on the third surface, wherein:
the first linear nozzle velocity, the second linear nozzle velocity, and the third linear nozzle velocity are a same linear nozzle velocity;
the third nozzle height relative to the third surface is higher than the first nozzle height relative to the first surface and lower than the second nozzle height relative to the second surface; and
the second porous layer of viscoelastic material is formed to have a lower porosity relative to a porosity of the porous layer of viscoelastic material.
